(19) United States
(12) Patent Application Publication
(10) Pub. No.: US 2014/0251836 A1
(43) Pub. Date: Sep. 11, 2014

(54) APPARATUS AND METHOD FOR ANALYZING MULTIPLE SAMPLES

(71) Applicant: MAGELLAN DIAGNOSTICS, INC., North Billerica, MA (US)

(72) Inventor: Rosemary Feeney, North Billerica, MA (US)

(73) Assignee: MAGELLAN DIAGNOSTICS, INC., North Billerica, MA (US)

(21) Appl. No.: 13/790,154

(22) Filed: Mar. 8, 2013

(51) Int. Cl. G01N 27/27

(52) U.S. Cl. CPC G01N 27/27
USPC 205/792; 204/403.03

(57) ABSTRACT

An apparatus and method for analyzing multiple samples is disclosed. In some embodiments, the apparatus and method use a multi-channel analyzer configured to simultaneously process results from a plurality of sample ports. The multi-channel analyzer further comprises a system for storing and transmitting the sample results from the plurality of samples, including unique sample identifiers. In some embodiments, the sample results may be transmitted to a laboratory information management system, a hospital network, or other similar location.

### BACKGROUND OF THE INVENTION

1. Field

This disclosure relates to an apparatus and method for measuring low levels of analytes in fluids in multiple samples and controlling and sorting the identities of the source of the samples.

2. Description of the Related Art

Electrochemical stripping and square wave voltammetry techniques have been developed using colloidal gold based sensors to measure concentrations of various analytes, such as lead in a mammalian blood sample. Some exemplary techniques and apparatuses are described in U.S. Pat. No. 5,873,990, the entirety of which is incorporated herein by reference. However, current sensors offer limited functionality with regard to high-throughput testing and interface with laboratory information management systems (LIMS). Thus, a need exists for an apparatus that provides high-throughput, high-accuracy sensors which provide a data interface with a LIMS, such as in a laboratory or hospital setting.

### SUMMARY

In one aspect, a multi-channel analyzer comprises a first processor and a first memory; a terminal in communication with the first processor and the first memory; a plurality of sensor ports, each of the sensor ports in communication with the first processor, wherein each of the sensor ports is configured to receive one of a plurality of removable sensors and analyze a sample on the one of the plurality of sensors, and wherein the first processor is configured to analyze the fluid samples on each of the plurality of removable sensors for an analyte, and each of the plurality of sensor ports is configured generate a sample result; a sample identification reader in communication with the first processor and the first memory, wherein the sample identification reader is configured to read a plurality of unique sample identifiers, each of the plurality of unique sample identifiers corresponding to a separate fluid sample; and wherein the first processor is configured to associate the unique sample identifier with the sample result from the corresponding one of the plurality of the sensor ports; and transmit the unique sample identifier and the associated sample result to the first memory.

In some embodiments, the first processor is further configured to transmit the sample identifier and the associated sample result to memory, where the sample identifier and the associated sample result are stored.

In some embodiments, the terminal further comprises a second processor and a second memory, and a communications module in communication with the second processor, the second memory, and a network.

In some embodiments, the second processor is configured to transmit the sample identifiers and the associated sample results stored in the second memory to the network via the communications module.

In some embodiments, the sample identifiers and the associated sample results are configured such that the sample identifiers and the associated sample results can be associated with patient records stored on the network.

In some embodiments, the network comprises a laboratory information management system or a hospital network.

In some embodiments, the first processor is configured simultaneously to analyze and generate sample results for each of the plurality of sensors inserted into the plurality of sample ports.

In some embodiments, the sample is blood and the analyte is lead.

In some embodiments, the multi-channel analyzer is configured to detect whether a sensor is wetted upon insertion into the sensor port.

In another aspect, a method of receiving and transmitting sample results comprises receiving a plurality of sensors in a plurality of sensor ports, wherein the sensor ports are electrically connected to a testing circuit; receiving a plurality of samples on the plurality of sensors; receiving a sample identifier corresponding to each of the plurality of samples; associating the sample identifier for each of the plurality of samples with the corresponding one the plurality of sensor ports; analyzing the plurality of samples on the plurality of sensors using the testing circuit to obtain a sample results for each sensor in each of the plurality of sensor ports; storing the sample results in a first memory; associating the sample result from each of the plurality of sensor ports with the corresponding sample identifier for each of the plurality of sensor ports; and transmitting the sample results and corresponding sample identifiers to a second memory.

In some embodiments, the sample results contained in the second memory and transmitting the sample results and the corresponding sample identifiers to a third memory.

In some embodiments, the third memory is remote from the first memory.

In some embodiments, the third memory is contained on a laboratory information management system or a hospital network.

In some embodiments, the sample results and the associated sample identifiers are transmitted to the laboratory information management system or hospital network such that the sample identifiers can be associated with patient identifiers stored on the laboratory information management system.

In some embodiments, the method further comprises sensing whether the sensor is wetted upon insertion of the sensor into the sensor port.

In some embodiments, analyzing the plurality of sensors comprises simultaneously analyzing each of the plurality of sensors inserted into the plurality of sensor ports.

### BRIEF DESCRIPTION OF THE DRAWINGS

FIG. 1A is a block diagram of an embodiment of a multi-channel analyzer system.

FIG. 1B is an depiction of a multi-channel analyzer system.

FIG. 2A is a block circuit diagram of a multi-channel analyzer.

FIG. 2B is a circuit diagram of a channel interface with a sensor of the multichannel analyzer of FIG. 2A.

FIG. 3 is a flow chart describing an embodiment of the operation of a multichannel analyzer.

FIG. 4 is a flow chart describing an embodiment of the operation of a multichannel analyzer connected to a terminal.

FIG. 5 is a flow chart depicting an embodiment of a method of processing sample results from a multichannel analyzer.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Disclosed in the present application are an apparatus, system, and methods for analyzing multiple samples for one or more analytes, identifying and storing sample identification and sample results, and making the sample results available on a LIMS or any other desired network. In some embodiments, the samples are blood samples placed on sensors which are readable using a multiple channel analyzer. In some embodiments, the blood samples are analyzed for blood lead concentration. Blood lead concentration analysis is described in U.S. Pat. No. 5,879,990, the entire contents of which are herein incorporated by reference.

As used herein, the terms simultaneously, or at the same time need not necessarily mean at exactly the same moment, and may mean that two actions or operations occur concurrently. For example, in the following disclosure, reference is made to analyzing sensors or performing operations at the same time or simultaneously. This need not mean that the sensors are analyzed, or that electrical signals are applied to each sensor at exactly the same moment. In some embodiments, an interrupt service request apportions processor time to the various sample ports, and may not actually send signals to more than one sample port at a time. However, due to the speed of the processor and the operations, the analysis or operations are effectively simultaneous, or, at least, appear to be simultaneous to the user. Similarly, where reference is made to operations on sensors occurring at the same time, this may mean that the operations occur at effectively the same time, or appear to occur at the same time, when in fact, the operations are sequenced within the processor, and do not occur at exactly the same time.

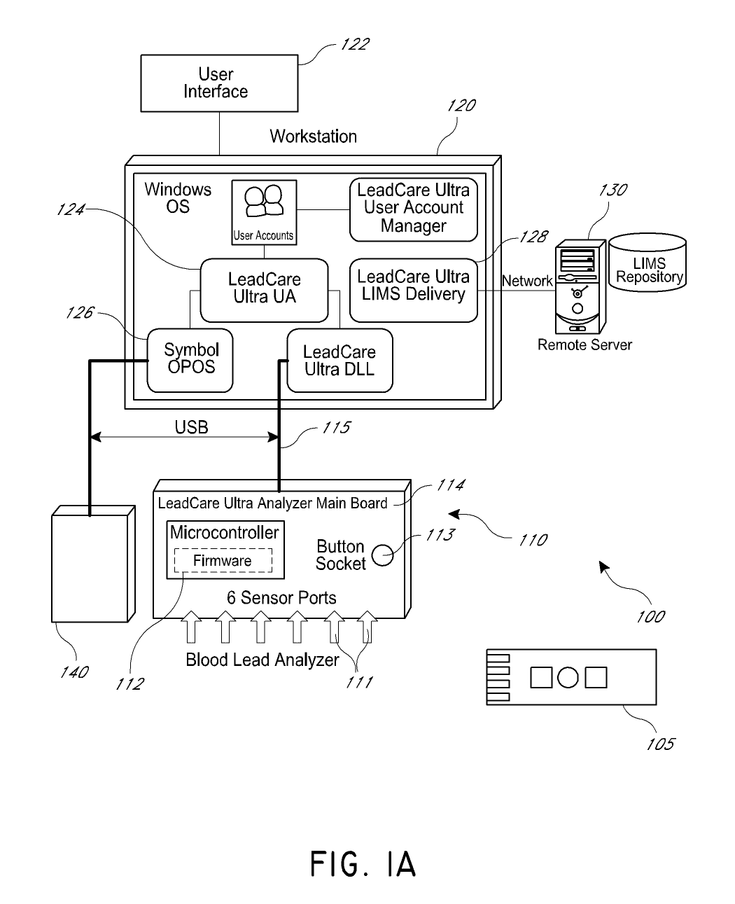

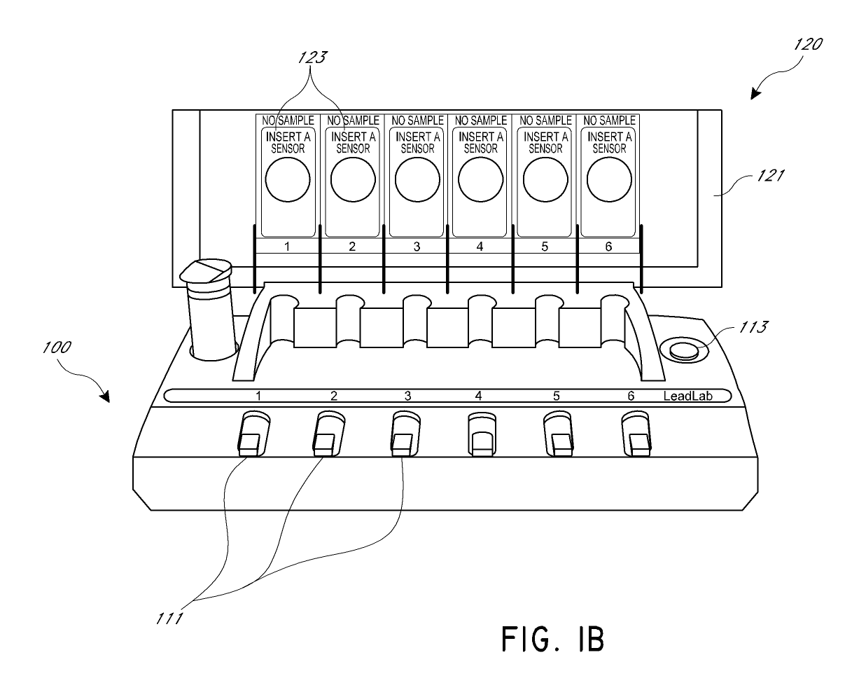

FIG. 1A is a block diagram of an embodiment of a multi-channel analyzer system 100. The multi-channel analyzer system 100 comprises an analyzer 110, a terminal 120, network 130, and an identifier input device 140. The analyzer 110, the terminal 120, and the network 130 are in communication with each other such that data and/or information can be shared among the various components.

The analyzer 110 comprises a plurality of sensor ports 111, a controller 112 containing firmware with operating instructions for the sensor ports, and a calibration node 113. The plurality of sensor ports may be formed in a housing 114, and may comprise openings in the housing 114 which are accessible to a sensor 105 external to the housing 114. The plurality of sensor ports 111 are preferably configured such that the external sensor 105 can be inserted into any one of the plurality of sensor ports 111. Each of the plurality of sensor ports 111 corresponds to a separate channel of the multichannel analyzer 100. In some embodiments, the multichannel analyzer 100 comprises 6 sensor ports, each of which is operable individually or concurrently with the others. Each of the plurality of sensor ports 111 comprises electrical circuitry which will be described in greater detail below.

The controller 112 comprises a processor and a memory, and is electrically connected to the circuitry of each of the sensor ports 111, and comprises instructions for operating the plurality of sensor ports 111 in conjunction with external sensor 105 inserted into one or more of the sensor ports 111. The controller is configured to provide electrical control signals to the circuitry of the plurality of sensor ports 111, and is configured to receive and process the electrical signals generated in the plurality of sensor ports 111. The electrical signals generated in the plurality of sensor ports 111 are a function of the amount of analyte in the sample on the external sensor 105. The controller 112 is further configured to receive from calibration node 113, calibration information for a particular batch of external sensors 105. The calibration information is used by the controller 112 in processing the electrical signals generated from the sensor ports 112 when analyzing a sample from sensor 105 from the particular batch of sensors for which the calibration information was provided.

The controller 112 is connected to the terminal 120 via a control line 115. The connection between the controller 112 and the terminal 120 enables the controller to receive control instructions from the workstation and associate sample identification information with the sensors in the plurality of sensor ports 111. The connection further allows the controller 112 to provide sample data generated in the plurality of sensor ports 111 to the terminal 120 for association with the sample identification information. The controller 112 comprises electrical circuitry which will be described in greater detail below.

Terminal 120 advantageously comprises a user input device 122 via which a user is able to initiate and direct operations of the multi-channel analyzer system 100. The terminal 120 further comprises a controller 124, an identifier input module 126, and a communications module 128. The controller 124 may comprise a processor, and a memory which stores user account information, sample identification information, and instructions for running a user interface program.

Controller 124 is connected to identifier input module 126, which is, in turn, connected to identifier input device 140. Identifier input module 140 is configured to receive an identifier and transmit the identifier to the identifier input module 126, wherein the controller 124 associates the identifier with sample information obtained from the analyzer 110. This process will be described in greater detail below.

Communication module 128 is configured to communicate with a computer or a computer network 130. The computer network 130 may comprise a LIMS database, or any other database suitable for storing sample and/or patient information, such as would be used in a hospital, laboratory, or clinical setting. Communications module 128 may comprise a wired connection or a wireless transceiver, or both. In this way, communications module 128 enables communication of information, which may include sample results from the plurality of sensor ports 111, identifier information from the identifier input device 140, and any other desired information.

Identifier input device 140 is configured to receive an identifier, such as a barcode, RFID tag, alphanumeric code, QR code, symbol, image, or any other desired identifier. In some embodiments, the identifier input device 140 may be a barcode reader, a scanner, an image detector, a camera, or any other desired input device. In some embodiments, the identifier may be located and read from external sensor 105. In some embodiments, identifier input device 140 is configured to scan a barcode located on a sample container which is applied to an external sensor 105.

FIG. 1B depicts a multi-channel analyzer system. Terminal 120 may comprise a graphical display device 121. The graphical display device 121 may provide visual status identifiers 123 of the state of each of the sensor ports 111 of the analyzer 100 attached to the terminal 120.

In some embodiments, terminal 120 may comprise a graphical user interface, which is displayed on the graphical display device 121, and which may be navigated and operated using by user input device 122. The user interface may be part of a system image that causes a standard computer to operate in a kiosk mode. Kiosk mode operation means that the operating system, which may be Windows® based, MacOS® based, Linux based, UNIX based, or based on any other desired operating system, is customized to only run the graphical user interface and the software for operating the analyzer 100 and terminal 120 as described herein. Kiosk mode operation may preclude access to a desktop, control panel, or other common features and functions of an operating system. Additionally, the kiosk mode operation allows for the creation and use of multiple user accounts wherein each user, or category of users, may have his or her own unique access credentials.

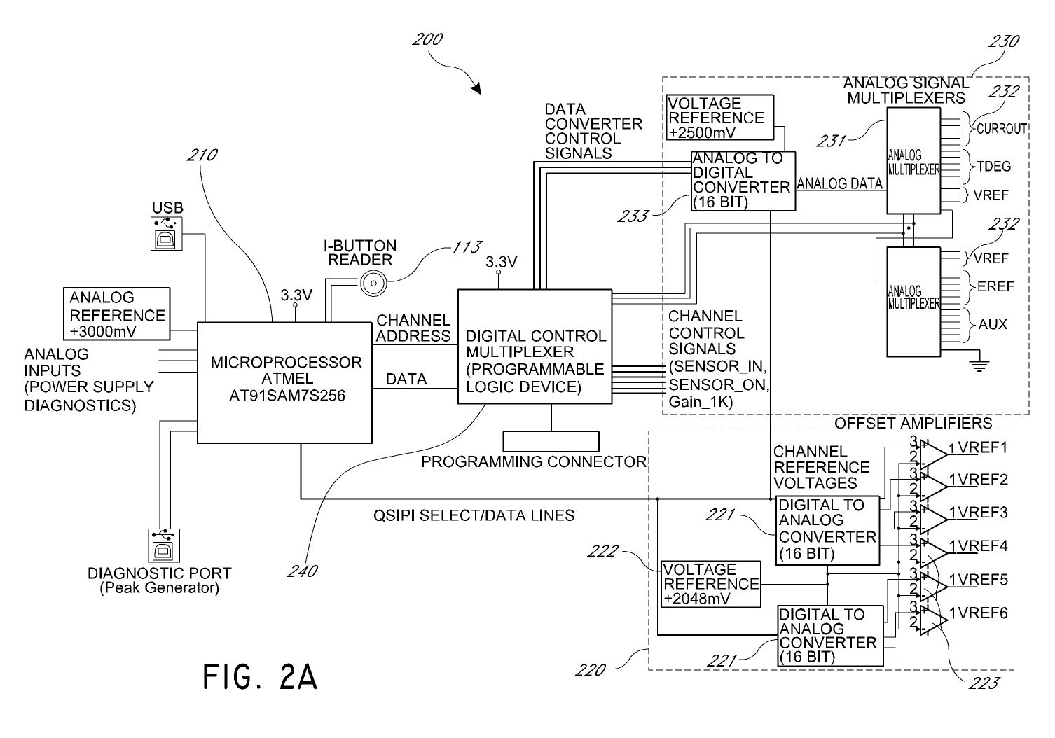

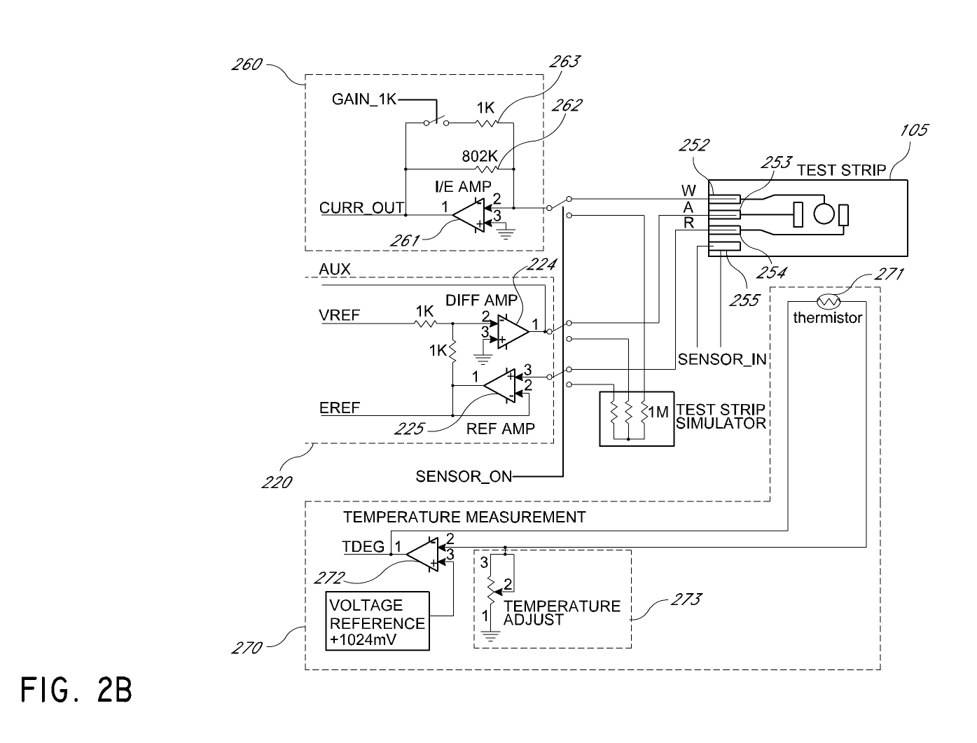

FIGS. 2A-B depict a circuit diagram of an embodiment of a portion of a controller and its interface with the plurality of sensor ports 111. For ease of illustration, only one sensor port and its associated circuitry is shown. As depicted, a controller 200, which may be similar to controller 112 described above, comprises a processor 210, a reference voltage supply unit 220, a sample signal receiving unit 230, a digital control multiplexer 240, a sensor connection region, a signal output unit 260, and a temperature compensation unit 270. The processor 210 controls all the functions of the controller 200, and may comprise on-board memory wherein the operating and control instructions for controller 200 and are stored. In some embodiments, the memory wherein operation and control instructions are stored may be external to the processor 210. The processor is in electrical communication with the reference supply voltage unit 220, the sample receiving unit 230, and the digital control multiplexer 240.

The reference supply voltage unit 220 comprises a plurality of a digital to analog converter (DAC) 221, a reference voltage supply 222, and a plurality of offset amplifiers 223, a plurality of difference amplifiers 224, and a reference amplifier 225.

The sensor 105 comprises a test contact 252, an auxiliary contact 253, a reference contact 254, and a sensor contact 255. Upon insertion of the sensor 105 into one of the plurality of sensor ports 111, the sensor contact 255 makes an electrical connection between a digital ground and an input to the digital control multiplexer 240, which is then transmitted to the processor 210. This provides a signal to the processor 210 that a sensor has been inserted into one of the plurality of sensor ports 111. The processor 210 identifies which of the plurality of sensor ports 111 contains a sensor 105 based on this signal.

As will be explained in greater detail below, when analysis of the sensor 105 begins, the processor 210 directs digital signals to the DAC 221, and DAC 221 converts the digital signals into analog voltages. The offset amplifiers receive the analog voltages from the DAC 221 and the reference voltage supply 222, and output an offset voltage from each of the offset amplifiers 223. In some embodiments, the offset voltage output from the reference voltage supply 222 is +2048 mV. The offset voltages from each of the offset amplifiers 223 is applied to the corresponding one of the plurality of difference amplifiers 224.

When a sample is placed on sensor 105 and is contacted with the test solution, an electrochemical voltage is generated at reference electrode 254. The reference voltage at reference electrode 254 is input to reference amplifier 225, and the output of reference amplifier 225 is input into difference amplifier 224. Difference amplifier 224 subtracts the offset voltage from the output of the reference amplifier 225. The difference amplifier 224 outputs a voltage to auxiliary contact 253 necessary to make the difference between the voltages at reference electrode 254 and auxiliary contact 253 equal to zero.

The sample signal receiving unit 230 comprises at least one analog multiplexer 231, each having a plurality of inputs 232, and an analog-to-digital converter (ADC) 233. The plurality of inputs 232 receive voltage and/or current signals from the signal output unit 260. In some embodiments, the signals received in the plurality of inputs 232 correspond to the quantity or amount of an analyte in the sample deposited on the sensor 105. The voltage and/or current signals received in the analog multiplexer(s) 231 are transmitted to the ADC 233, where the voltage and/or current signals are converted to a digital signal, which is then transmitted to the digital control multiplexer 240. The processor 210 may then transmit the digital signal, which may correspond with the amount of analyte in the sample being tested, to the terminal 120 for further processing by controller 124 and programs maintained on the terminal 120.

Signal output unit 260 comprises a current-to-voltage (I/E) amplifier 261, a first resistor 262, and a second resistor 263, both of which are located in the feedback path of the I/E amplifier. In some embodiments, a switch 264 may be in series with the second resistor 263. Operation of switch 264 either applies or removes current flow through the resistor, thus altering the gain of the I/E amplifier. The first and second resistors 262 and 263 may have various ratings or provide various amounts of resistance, depending on the desired gain for the sensor 105 being tested. In some embodiments, the first resistor 262 has a resistance of 802KΩ, and the second resistor has a resistance of 1KΩ.

The temperature compensation unit 270 comprises a thermistor 271, an operational amplifier 272 and a temperature adjust control 273. In some embodiments, the thermistor 271 may be a 10KΩ thermistor. The temperature compensation unit 270 allows for compensation of voltages depending on the sensed temperature at the plurality of sensor ports 111.

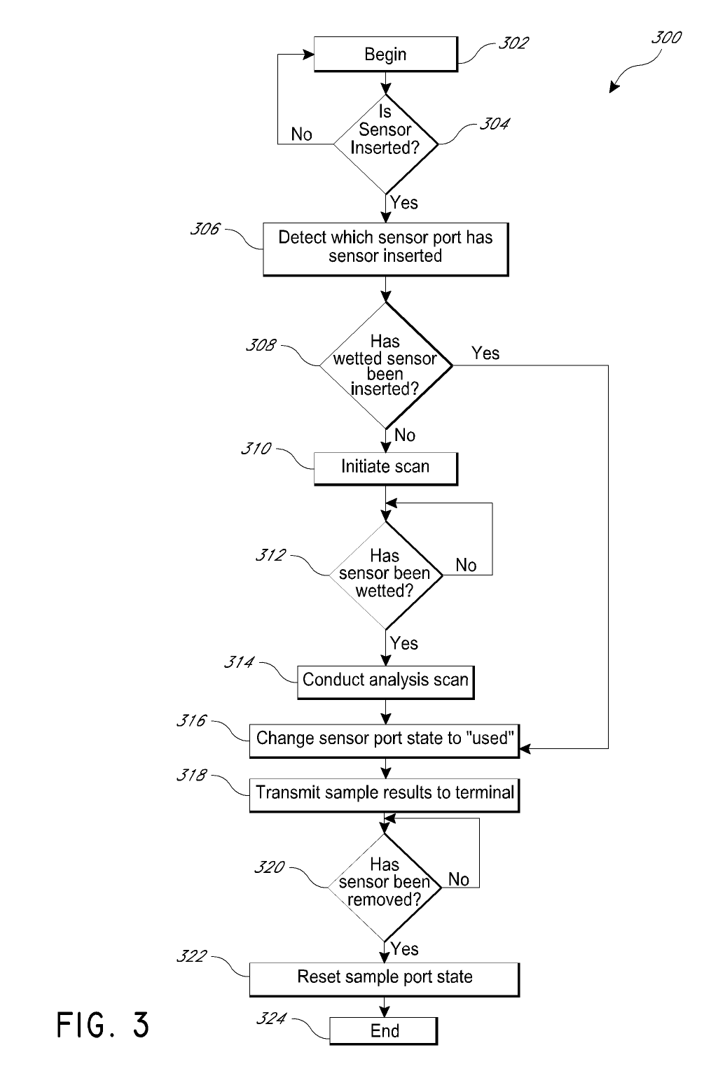

The operation of the controller 200 and the plurality of sensor ports 111 will now be described with respect to FIG. 3. Each sensor port 111 is assigned a channel within the controller 200, and the processor 210 and the digital control multiplexer 240 are configured to detect, operate, and process sensors 105 in each of the plurality of sensor ports 111 at once, or on a staggered basis. That is, the controller 200 is configured to direct the analysis of samples in multiple different sample ports 111 which are initiated at different times and/or proceed on a different timeline. An exemplary process begins at block 302. At block 302, the multichannel analyzer may perform a self-test or other pre-use routines. The process moves to decision state 304, wherein it is determined whether a sensor is inserted. A sensor detection circuit exists for each of the plurality of sensor ports 111, such that the processor 210 and the digital control multiplexer 240 may monitor a circuit for each of the plurality of sensor ports 111. To determine whether a sensor is inserted, the processor 210 and the digital control multiplexer 240 monitor a sensor detection circuit for a connection between a digital ground and an input to the digital control multiplexer 240. When a sensor 105 is inserted into one of the plurality of sensor ports 111, a connection is made between the digital ground and the sensor contact for the associated sensor port 111. The connection signals the processor 210 and the digital control multiplexer 240 that a sensor has been inserted into one of the plurality of sensor ports 111. Once a sensor 105 is inserted into a sensor port 111, the sensor inserted state is latched in the controller 200 such that any removal of the sensor 105 from the sensor port 111 is detected.

If a sensor 105 has not been detected in a sensor port 111, the process returns to block 302, where the process waits until a sensor is detected. Although described herein in terms of a process flow, note that an interrupt could similarly be used to signal that a sensor has been inserted. If a sensor 105 is detected in one of the plurality of sensor ports, the process moves to block 306, wherein the processor 210 and the digital control multiplexer 240 identify into which sensor port 111 the sensor 105 was inserted, and the associated channel within controller 200. The processor 210 and the digital control multiplexer 240 identify which sensor port 111 has established the sensor detection connection via sensor contact 255. The controller 200 is configured to identify concurrently the presence of sensors 105 in every sensor port 111 or a combination of sensor ports 111.

The process then moves to decision state 308, wherein it is determined whether a wet sensor has been inserted into sample port 111. Upon detecting the presence of a sensor 105 in one of the sample ports 111, the processor 210 performs a “wet detect” process. A “wet detect” process comprises supplying a ramping or sawtooth voltage to the auxiliary contact 253 of the sensor port 111 in which the sensor 105 has been detected. In some embodiments, the wet detect process may be performed on more than one sensor port 111 at the same time. In some embodiments, the ramping or sawtooth voltage may vary between −100 mV and +100 mV. A dry sensor 105 does not have a connection path between the auxiliary contact 253 and the test contact 252, and thus, where the sensor is dry, no signal will be detected in the analog output multiplexer 231. Where no signal is detected on application of the ramping or sawtooth voltage, the sensor 105 is determined to be dry. If, on application of the ramping or sawtooth voltage to the auxiliary contact 253, a signal is detected in the analog output multiplexer 231, the sensor 105 is determined to be a wet sensor, and the process moves to block 316, which will be described in greater detail below. If the sensor 105 is determined to be dry, the process proceeds to block 310, wherein the testing or scanning sequence is initiated.

After initiation, the process moves to decision state 312 wherein it is determined whether the sensor 105 is wetted. Here, the processor 210 directs performance of the wet detect process described above, by applying a ramping or sawtooth voltage to the auxiliary contact 253 of the inserted sensor 105. If the sensor is dry, or in other words, is not determined to be wetted, the wet detect continuously repeats until the sensor is determined to be wetted. Wetting of the sensor 105 occurs when a sample and/or reagent is applied to the sensor 105, thereby forming a conductive pathway between the test contact 252 and the auxiliary contact 253, as well as the reference contact 254, and a signal is output to the I/E amplifier 261. This signal indicates that the sample has been wetted. In some embodiments, the processor 210 looks for 5 consecutive wet signals within four seconds in order to determine that the sensor 105 has been wetted.

If the sensor is determined to be wetted, the process moves to block 314, wherein the state of the sensor port 111 containing the wetted sensor 105 is changed to a testing state, and the analysis scan is initiated. The analysis scan can be performed using anodic stripping voltammetry and square wave voltammetry to determine the quantity of an analyte such as lead, hemoglobin, or other desired analyte in a sample, e.g., a blood sample. The techniques of anodic stripping voltammetry and square wave voltammetry are described in more detail in U.S. Pat. No. 5,873,990. The controller 200 directs the analysis scan, and a scan result is generated.

As described above, the controller 200 is configured to perform the analysis on multiple channels, or on multiple sensors 105 inserted into multiple sensor ports 111, at the same time. In some embodiments, the interaction of the plurality of sample ports 111 is done using an interrupt service routing (ISR), which supports both the timing requirements of the analysis and hardware access. Since all channels tasks must access the various circuit components, such as, for example, the DACs 221, the ADCs 233, and the like, the ISR can be used to resolve some or all timing issues. The ISR can also direct generation of the sensor presence, wet detect signals and the analysis signals. In some embodiments, the analysis scan frequency is 115 Hz, and is divided into forward and reverse half-steps, resulting in a fundamental scan or analysis signal period of approximately 4.348 milliseconds. In some embodiments, the wet detect signal is a 5 Hz waveform. In order to allow all channels to perform wet detects, or analysis scans at the same time, each half-period is divided into a number of slots, and each slot is assigned a dedicated action which is performed for each channel that is active, or into which a sensor 105 has been inserted and detected. In some embodiments, the half-period is divided into 44 slots, which results in an ISR period of approximately 98.8 microseconds.

Referring now to the wet detect process of decision state 312, a specified number of slots within the analysis scan frequency are assigned for ramping or sawtooth waveform generation. In some embodiments, four slots are assigned for sawtooth waveform generation. In some embodiments, slots 3, 14, 25, and 36 are assigned for sawtooth generation. If a channel or sensor port is in the wet detect portion of the process described above, then an event flag will be set just before each sawtooth peak to inform the channel to take a reading at the ADC. The wet detect channel task then queues the ISR to take a reading at the ADC, and check the result for a wet sensor detection.

By using the ISR to control hardware and timing requirements, all the channels, and thus all the sample ports 111, may have wet detects and/or analysis scans running at the same time.

Upon completion of the analysis scan in block 314, the process then moves to block 316, wherein the state of the sensor port is changed from a testing state to a “used” state. In some embodiments, once a sensor port 111 has been changed to the “used” state, the “used” state on that channel and sensor port 111 cannot be exited until the sensor 105 is withdrawn.

As described earlier, in decision state 308, if a wet sensor 105 is inserted into sensor port 111, the sensor port and the associated channel are placed into the “used” state, and cannot be used until the wetted sensor 105 is removed from the sensor port 111. This prevents an analysis on a sensor 105 which has previously been used, or may have another error condition.

The process next moves to block 318 wherein the sample results generated in block 314 are transmitted to terminal 120. Following transmission of sample results in block 314, the process moves to decision state 320, wherein the processor 210 checks whether the sensor 105 has been removed from the sensor port 111. If the sensor 105 has not been removed, the process waits until the sensor 105 is removed. If the sensor has been removed, the process proceeds to block 322, wherein the state of the channel and sample port are reset. The process then ends in block 324.

Throughout process 300, the controller 200 is in communication with the terminal 120, and the terminal 120 provides a user interface for using the analyzer 100. In some embodiments, the terminal 120 provides graphical indications of the states of the sensor ports, and displays the sample results, based on signals received from the controller 200. It will be understood that the order of the steps in process 300 is exemplary, and that the steps of process 300 may be performed in different orders from that depicted.

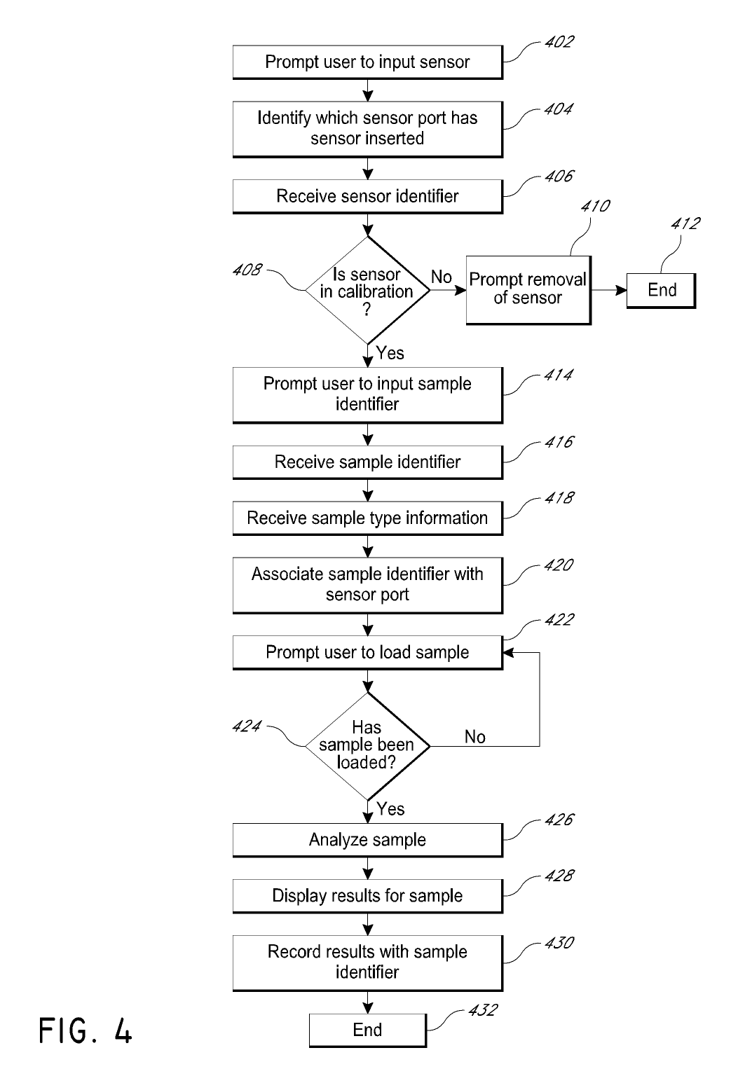

FIG. 4 is a flow chart depicting a process for operating the user interface using terminal 120 to perform sample analyses on analyzer 100. The process 400 starts at block 402, wherein the user interface prompts a user to insert a sensor 105 into one of the plurality of sample ports 111. In some embodiments, the terminal 120 is configured to provide visual status identifiers 123 visually depicting the status of each of the plurality of sample ports 111 in the attached analyzer 100, as shown in FIG. 1B. In some embodiments, the user interface may provide a prompt to insert a sensor 105 into each of the plurality of sample ports 111. In some embodiments, the prompt may be a graphical prompt displayed on a screen of terminal 120, an audio signal, or any other desired prompt or combination of prompts. For example, the visual status indicator 123 for the associated sample port 111 may depict a request to insert a sensor. The process 400 waits until a sensor 105 is inserted into a sample port 111.

Once a sensor 105 is inserted into a sample port 111, the process moves to block 404, wherein the terminal identifies the sample port 111 into which a sensor 105 has been inserted. If more than sensor port 111 have received sensors 105, each sample port 111 containing a sensor 105 is identified. This identification may be indicated graphically on the terminal 120, textually, using an alphanumeric string, audibly, or by any other desired means. In order to provide an identification of the sensor ports 111 containing sensors 105, the terminal is configured to receive a signal from the analyzer 100 and controller 200 indicating which sensor ports 111 have received a sensor 105.

The process next moves to block 406 wherein a user is prompted to enter a sensor identification. The sensor identification may correspond to the lot or batch number of the sensors. To prompt entering sensor identification information, for example, the visual status indicator 123 for the associated sample port 111 may be changed to request inputting a sensor identifier. In some embodiments, the sensor may not have a sensor identification and block 406 may not be performed.

The process next moves to decision state 408 wherein it is determined whether the calibration data is current for the inserted sensor 105. The terminal transmits the sensor identification to the controller 200, which compares the sensor identification with the calibration information received from calibration node 113. If the sensor identification indicates that the inserted sensor 105 is from a lot or batch of sensors whose calibration data has been loaded into analyzer 100, then the sensor is determined to be calibrated. If the sensor identification does not correspond to a batch or lot of sensors whose calibration information has been loaded into analyzer 100, it is determined that the sensor is not calibrated. If the sensor 105 is determined to be not calibrated, the process 400 moves to block 410, wherein the terminal 120 displays a message that the sensor is not calibrated, that the calibration has expired, or another similar message. The terminal prompts removal of the sensor, and no analysis of the sensor 105 is allowed. The process then ends in block 412.

In some embodiments, the calibration data provided to the analyzer 100 comprises a calibration expiration date. Upon insertion of a sensor, the analyzer 100 evaluates the calibration expiration date of the calibration data in the analyzer 100 against the current date. If the calibration expiration date has passed, a sensor is determined to be not calibrated, and the process 400 moves to block 410, as described above. If the calibration expiration date has not yet passed, the sensor is determined to be in calibration.

If the sensor is determined to be in calibration, the process moves to block 414, wherein the user is requested to input a sample identification. The sample identification may be input using the identification input device 140. In some embodiments, the sample identification may be input as a barcode read with using a barcode scanner. In some embodiments, the sample identification may be input as an alphanumeric string using a keyboard or manual input device. A sample identification is requested for each sample port 111 containing a sensor 105. In some embodiments, the visual status indicator 123 for the associated sample port 111 may depict a request to scan a barcode or otherwise input a sample identification.

The process 400 next moves to block 416, wherein the input identifier module 126 receives the sample identification, and transmits the sample identification to controller 124 of terminal 120. The controller 124 receives the sample identification.

The process next moves to block 418, wherein the terminal requests a sample type. The sample type may correspond to the location from which the sample was drawn on a subject. For example, if the sample is blood, the sample type may be capillary, fingerstick, vein, or other location. In some embodiments, the sample type may be selectable with a radio button on the user interface.

Moving to block 420, the controller 126 associates the received sample identification and sample type information with the sensor port 111 into which the particular sensor 105 is inserted. The sample identification, the sample type, and the associated channel or sample port information are stored in a database. In some embodiments, the database is located on the terminal 120. In some embodiments, the database may be remote to the terminal 120.

The process next moves to block 422, wherein the user is prompted to add or apply a sample to the sensor 105 via the sample port 111. The prompting may be accomplished by updating the visual status indicator 123 for the associated sample port to request loading a sample into the sensor 105.

The process next moves to decision state 424, wherein it is determined whether a sample has been loaded into the sensor 105. Detecting the presence of a sample on the sensor 105 is described above, and the controller 124 receives the information regarding the presence or absence of a sample on a sensor from the analyzer 100 via connection 115. If a sample is not loaded, the process 400 returns to block 422, and repeats until a sample is loaded.

When a sample is loaded, the process moves to block 426 wherein the sample is analyzed as described elsewhere herein. During analysis the visual status indicator 123 may be updated to reflect that the sample port 111 is in an analysis state. In some embodiments, the visual status indicator 123 may display a countdown timer or other indication of time remaining in the analysis. The sample results are stored in the memory of analyzer 100.

The process 400 next moves to block 428, wherein the analyzer 100 transmits the results of the sample analysis to the terminal 120, to be stored in the memory of terminal 120. The sample results are displayed on terminal 120. In some embodiments, the sample results may be displayed on the visual status indicator 123 for the sensor port 111 which analyzed the sample.

The process 400 next moves to block 430, wherein the controller 124 associates the sample results from a particular sample port 111 with the sample identifier and sample type for that sample port 111 previously stored in the database. In some embodiments, the controller associates with the sample result and stores the time, date, and identity of the user in the database. The process then ends at block 432.

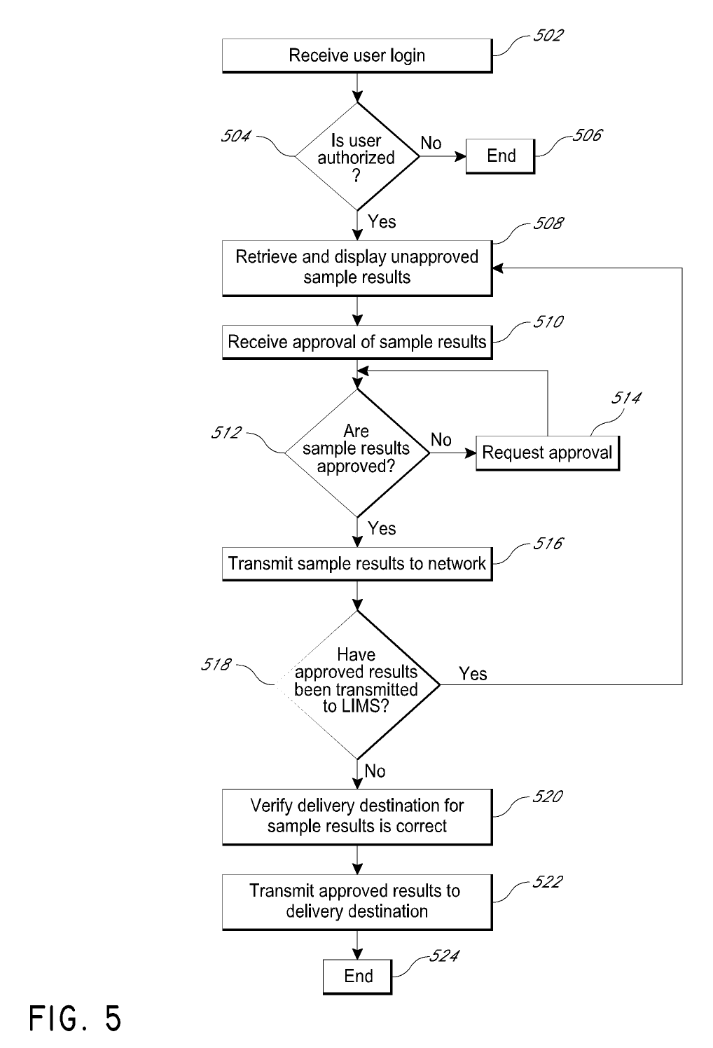

In some embodiments, it may be desirable to provide the sample results together with the sample identification information to a recipient, such as a database, a LIMS, a hospital network, a patient management system, or any other desired system. FIG. 5 is a flowchart illustrating a method of handling and transmitting sample information.

The process 500 begins in block 502, wherein the terminal 120 receives a user identification or credentials, such as a user login, username, password, or other identification via user input device 122. The process then moves to block 504, wherein it is determined if the user has proper access rights or permissions to log in to the terminal 120 and the user interface, including the programs, interfaces, and/or software that control the sampling processes described with reference to FIGS. 4 and 5. The user is identified, or, in other words, a user's permission or access rights are verified by comparing the inputted user identification information to the user identification information stored in a database or memory of terminal 120. In some embodiments, the user identification information is compared to user identification stored on a remotely accessible database, server, or any other desired network. In some embodiments, the user identification information may be input using input identification device 140, by, for example, scanning a bar code on a user ID badge, or any other desired method.

If the user cannot be identified, or if the user does not have adequate permissions or access rights, the user is not allowed access to the terminal 140, and the process ends at block 506. If the user identification information is authenticated, or if the user has sufficient permissions or access rights, the user is logged in to the terminal 120, and the process proceeds to block 508.

In block 508, sample results and sample identifications from a plurality of samples can be retrieved and viewed. In some embodiments, a user may access and retrieve all the sample results, or may select to retrieve only sample results which meet a certain criteria, such as, for example, all the sample results having a common sample identification, results for a specified time frame, a specific channel of the analyzer, all results performed by a specific user, or any other desired criteria.

After retrieving the sample results for a plurality of samples stored within the database of terminal 120, the process 500 moves to block 510, wherein a user approves the retrieved sample results. When a sample is initially analyzed in analyzer 100, the results are stored in a database on terminal 120. The user accesses the database of sample results and selects sample results for approval. Approval may be performed based on a variety of criteria. For example, the system may require sample results may need to be reviewed by a user before they can be processed or transmitted, in order to check for errors or erroneous readings. Upon approval of sample results, all the approved sample results are stored in a first location on a database on terminal 120, and each sample is stored with its corresponding sample identification information. In some embodiments, the approved sample results may also comprise the measurement of the analyte within the sample, the sample time, sample location, the channel or sample port 111 used to analyze the sample, the sensor lot or batch number, and any other desired information regarding the sample. The first location may be separate from the location where all the sample results are stored upon completion of analysis of the samples. In some embodiments, the first location may be a specific file of approved sample results stored on a memory in terminal 120.

The process 500 moves to decision state 512, wherein it is determined what sample results have been approved. In some embodiments, if sample results have been approved, a separate file will exist within the memory of terminal 120. If there are no approved sample results, the process 500 moves to block 514, wherein approval of sample results is requested, or a notification of the lack of approved sample results is provided.

If approved sample results are available, the process moves to block wherein the approved sample results are submitted to a second location, or a delivery location. The first and second/delivery locations may be selected and/or defined by the user. In some embodiments, the second location is on a remote server or network, such as a LIMS, a hospital network, or any other desired location. In some embodiments, if the approved sample results file is found, it is automatically transmitted with to the second location. In some embodiments, the transfer of approved sample results and sample identification information may occur automatically. In some embodiments, a user can initiate transfer of approved sample results using the user interface program of terminal 120. In some embodiments, the sample results sent to a LIMS may be received and processed in a LIMS such that the sample identifiers from the multi-channel analyzer may be associated with patient identifiers which are stored on the LIMS, and the sample results for each individual patient may be accessible to a health care professional.

The process then moves to decision state 518, wherein it is determined whether the approved sample results have been transmitted to the second location. If the approved results have been successfully transferred, the process 500 returns to block 508, wherein the user can retrieve and approve additional sample results, if desired. If the approved results have not been transferred, or if an error in the transfer was detected, the process moves to block wherein the second location, or approved sample results delivery location is verified. A user may be prompted to input or select the desired delivery location, update previously stored delivery location information.

Once the second or delivery location has been selected or verified, the process moves to block 522, wherein the approved sample results are transmitted to the selected second or delivery location. In some embodiments, transmitting the results to a second or delivery location may comprise creating a back-up copy of the sample results, or storing the sample results in a long-term, reliable computer readable medium, such as a hard drive, an optical disk, long-term flash memory, or any other desired computer writable/readable medium. The process then ends in block 524.

A person of skill in the art will understand that the steps of processes 300, 400, and 500 need not be performed in the order specified. Furthermore, a person of skill in the art will understand that the processes may be performed in parallel, and no steps in one process necessarily preclude the performance of steps in another process. In some embodiments, the processes occur in an overlapping fashion, with steps from one process giving rise to or, initiating steps from another process, or steps from one process being triggered by steps from another process.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, controllers, microcontrollers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Core I3, I5, or I7 processor, a 8051 processor, an AMD FX series processor, a MIPS® processor, an Atom processor, or an Alpha® processor. In addition, the processor may be any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as Linux®, UNIX® or Microsoft Windows®.

The system may be written in any conventional programming language such as C, C++, BASIC, Pascal, or Java, and run under a conventional operating system. C, C++, BASIC, Pascal, Java, and FORTRAN are industry standard programming languages for which many commercial compilers can be used to create executable code. The system may also be written using interpreted languages such as Perl, Python or Ruby.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A multi-channel analyzer comprising:
a first processor and a first memory;
a terminal in communication with the first processor and the first memory;
a plurality of sensor ports, each of the sensor ports in communication with the first processor, wherein each of the sensor ports is configured to receive one of a plurality of removable sensors and analyze a sample on the one of the plurality of sensors, and wherein the first processor is configured to analyze the fluid samples on each of the plurality of removable sensors for an analyte, and each of the plurality of sensor ports is configured generate a sample result;
a sample identification reader in communication with the first processor and the first memory, wherein the sample identification reader is configured to read a plurality of unique sample identifiers, each of the plurality of unique sample identifiers corresponding to a separate fluid sample; and wherein the first processor is configured to:
associate the unique sample identifier with the sample result from the corresponding one of the plurality of the sensor ports; and
transmit the unique sample identifier and the associated sample result to the first memory.

2. The multi-channel analyzer of claim 1, wherein the first processor is further configured to transmit the sample identifier and the associated sample result to memory, where the sample identifier and the associated sample result are stored.

3. The multi-channel analyzer of claim 1, wherein the terminal further comprises a second processor and a second memory, and a communications module in communication with the second processor, the second memory, and a network.

4. The multi-channel analyzer of claim 3, wherein the second processor is configured to transmit the sample identifiers and the associated sample results stored in the second memory to the network via the communications module.

5. The multi-channel analyzer of claim 4, wherein the sample identifiers and the associated sample results are configured such that the sample identifiers and the associated sample results can be associated with patient records stored on the network.

6. The multi-channel analyzer of claim 4, wherein the network comprises a laboratory information management system or a hospital network.

7. The multi-channel analyzer of claim 1, wherein the first processor is configured simultaneously to analyze and generate sample results for each of the plurality of sensors inserted into the plurality of sample ports.

8. The multi-channel analyzer of claim 1, wherein the sample is blood and the analyte is lead.

9. The multi-channel analyzer of claim 1, wherein the multi-channel analyzer is configured to detect whether a sensor is wetted upon insertion into the sensor port.

10. A method of receiving and transmitting sample results comprising:
receiving a plurality of sensors in a plurality of sensor ports, wherein the sensor ports are electrically connected to a testing circuit;
receiving a plurality of samples on the plurality of sensors;
receiving a sample identifier corresponding to each of the plurality of samples;
associating the sample identifier for each of the plurality of samples with the corresponding one the plurality of sensor ports;
analyzing the plurality of samples on the plurality of sensors using the testing circuit to obtain a sample results for each sensor in each of the plurality of sensor ports;
storing the sample results in a first memory;
associating the sample result from each of the plurality of sensor ports with the corresponding sample identifier for each of the plurality of sensor ports; and
transmitting the sample results and corresponding sample identifiers to a second memory.

11. The method of claim 10 further comprising approving the sample results contained in the second memory and transmitting the sample results and the corresponding sample identifiers to a third memory.

12. The method of claim 11 wherein the third memory is remote from the first memory.

13. The method of claim 10, wherein the third memory is contained on a laboratory information management system or a hospital network.

14. The method of claim 13, wherein the sample results and the associated sample identifiers are transmitted to the laboratory information management system or hospital network such that the sample identifiers can be associated with patient identifiers stored on the laboratory information management system.

15. The method of claim 10 further comprising sensing whether the sensor is wetted upon insertion of the sensor into the sensor port.

16. The method of claim 10, wherein analyzing the plurality of sensors comprises simultaneously analyzing each of the plurality of sensors inserted into the plurality of sensor ports.
